(19) United States
(12) Patent Application Publication
(10) Pub. No.: US 2005/0095976 A1
(43) Pub. Date: May 5, 2005

(54) Design for LPT arm cover

(75) Inventors: Huan-Liang Tzeng, Hsinchu City (TW); Jung-Hsiang Chang, Hsinpu Town (TW); Lin-Wei Wang, Banciao City (TW)

Correspondence Address: DUANE MORRIS, LLP;IP DEPARTMENT, ONE LIBERTY PLACE, PHILADELPHIA, PA, 19103-7396, US

(73) Assignee: Taiwan Semiconductor Manufacturing Co.

(21) Appl. No.: 10/696,642

(22) Filed: Oct. 29, 2003

(51) Int. Cl. B01L 1/04

(52) U.S. Cl. 454/187

(57) ABSTRACT

A load port transfer mechanism having reduced particle contamination is described. The load port transfer mechanism comprises a load port transfer arm over which extends a cover and a means for blowing air past the load port transfer arm. The cover shields the load port transfer arm from particle contamination.

### BACKGROUND OF THE INVENTION

(1) Field of the Invention

The present invention relates to load port transfer devices, and more particularly, to a new design of load port transfer devices having improved particle rates.

(2) Description of the Prior Art

In the manufacture of integrated circuits, wafers are transferred between various machines and tools where various semiconductor processes are performed. Some of these machines include vacuum load lock equipment and cluster tools. Typically, wafers are placed into a cassette holder containing a number of wafers. In today's automated fabs, the wafer cassette is loaded into a transfer system which uses automated equipment to control the flow of material. One type of transfer device is a load port transfer (LPT). This device consists of a robotic arm or standard mechanical interface (SMIF) arm which removes a wafer cassette from the load port of one tool and moves the cassette either to a storage area or to the load port of another tool. Especially in semiconductor manufacturing, particle contamination is a serious problem. Particles in the environment will flow into the load port transfer (LPT) arm area if the pressure in the LPT arm area is too low. When a high class particle level is required (i.e. very low number of particles), a high cost mini-environment may be installed surrounding the LPT arm area.

There are a number of patents in the field of transfer systems. U.S. Pat. No. 6,351,686 to Iwasaki et al shows a load arm having no cover. U.S. Pat. No. 6,481,558 to Bonora et al describes a transfer system having a lifting mechanism. U.S. Pat. No. 6,517,304 to Matsumato discloses a mini-environment surrounding a load port transfer mechanism to minimize particle contamination. U.S. Pat. No. 6,315,512 to Tabrizi et al shows methods to eliminate particle contamination including a mini-environment.

### SUMMARY OF THE INVENTION

Accordingly, it is a primary object of the invention to provide an effective method for minimizing particles in a load port transfer device.

Another object of the present invention is to provide a load port transfer mechanism having reduced particle contamination.

Yet another object is to provide a load port transfer mechanism having reduced particle contamination without a mini-environment.

A further object is to provide a load port transfer mechanism having reduced particle contamination by means of a cover over the load port transfer arm.

In accordance with the objects of this invention, a load port transfer mechanism having reduced particle contamination is achieved. The load port transfer mechanism comprises a load port transfer arm over which extends a cover and a means for blowing air past the load port transfer arm. The cover shields the load port transfer arm from particle contamination.

### BRIEF DESCRIPTION OF THE DRAWINGS

In the following drawings forming a material part of this description, there is shown:

FIG. 1 is a side view of the load port transfer mechanism of the present invention.

FIG. 2 is a side view of the protective cover of the load port transfer mechanism in FIG. 1.

FIG. 3 is a cross-section of the protective cover of FIG. 2.

### DESCRIPTION OF THE PREFERRED EMBODIMENTS

The present invention provides a load port mechanism having reduced particle contamination without a mini-environment. Although a mini-environment will solve the particle contamination problem, it carries a high cost. The present invention provides reduced particle contamination without the need for the high cost of a mini-environment.

A specially designed cover has been proposed to generate a clean air environment in the area of the LPT arm and to maintain clean air in the region of the LPT arm and the tool with which the LPT arm interacts.

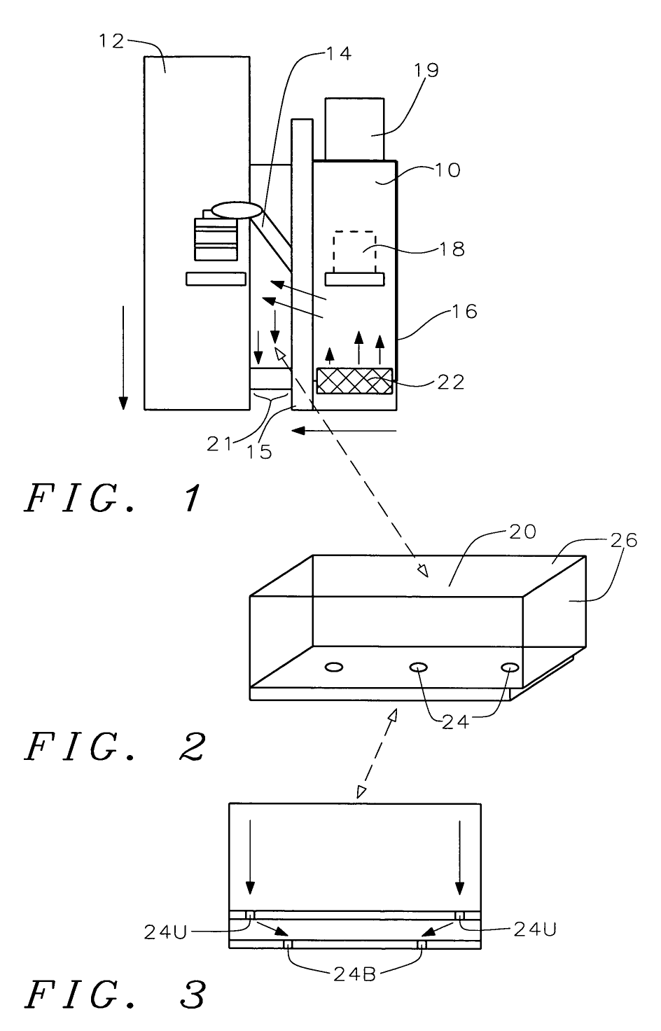

FIG. 1 shows the LPT mechanism 10. 12 is the tool with which the LPT arm interacts; for example, an etching machine. 14 is the robotic LPT arm. 15 is the LPT arm side cover. The cassette pod 19 is shown. Cassettes are moved to or from the cassette pod by the LPT arm. 18 is the LPT arm index.

FIG. 2 illustrates the cover of the present invention. The cover has four sides 26 with open ends. The acrylic cover is installed between the region of the machine and the LPT arm, as shown by 21 in FIG. 1. Pressure release holes 24 are formed in the base of the cover. These holes have a diameter of about 3 mm. FIG. 3 is a cross-section of FIG. 2, showing the holes 24U formed in an upper layer of the bottom of the cover and holes 24B formed in a lower layer of the bottom.

A fan filter 22 blows clean air over the LPT arm in order to blow away particles and maintain the pressure surrounding the LPT arm at a higher level than the pressure of the clean room environment. This higher pressure will prevent particles from flowing over the LPT arm.

The protective cover of the present invention acts as a shield between the LPT arm and the machine tool, preventing particles from the clean room from entering the environment of the machine.

The load port transfer device of the present invention having a cover over the LPT arm provides for a reduction of particle contamination. The LPT device of the present invention has demonstrated a particle count of fewer than 3.5 particles greater than 0.1 microns in size. Since it is not necessary to install a mini-environment apparatus, the cost savings are significant.

While the invention has been particularly shown and described with reference to the preferred embodiments thereof, it will be understood by those skilled in the art that various changes in form and details may be made without departing from the spirit and scope of the invention.

1. A load port transfer apparatus comprising:
(a) a load port transfer arm comprising a robotic arm or mechanical interface arm configured to remove a wafer cassette from a load port of a tool, the load port transfer arm having a cover thereover; and
(b) a means for blowing air around said load port transfer arm.

2. The apparatus according to claim 1 wherein said cover comprises acrylic.

3. The apparatus according to claim 1 wherein said means for blowing air comprises a fan filter.

4. The apparatus according to claim 1 wherein said cover comprises a box having a top, a bottom, and two ends and having two open sides.

5. The apparatus according to claim 4 wherein said cover has openings in said bottom for releasing air into the ambient.

6. The apparatus according to claim 5 wherein said bottom of said cover comprises an upper layer and a lower layer and wherein a first set of said openings are formed in said upper layer and a second set of openings are formed in said lower layer and wherein said first set of openings and said second set of openings are discontinuous.

7. A load port transfer apparatus comprising:
(a) a load port transfer arm comprising a robotic arm or mechanical interface arm configured to remove a wafer cassette from a load port of a tool, the load port transfer arm having a cover thereover wherein said cover covers a top, bottom, and two end surfaces of an area surrounding said load port transfer arm and wherein two side surfaces of said area are open so that said load port transfer arm can move without restraint; and
(b) a means for blowing air around said load port transfer arm and out through openings in said bottom of said cover.

8. The apparatus according to claim 7 wherein said cover comprises acrylic.

9. The apparatus according to claim 7 wherein said means for blowing air comprises a fan filter.

10. The apparatus according to claim 7 wherein said bottom of said cover comprises an upper layer and a lower layer and wherein a first set of said openings are formed in said upper layer and a second set of openings are formed in said lower layer and wherein said first set of openings and said second set of openings are discontinuous.

11. A load port transfer apparatus comprising:
(a) a load port transfer arm comprising a robotic arm or mechanical interface arm configured to remove a wafer cassette from a load port of a tool, the load port transfer arm having an acrylic cover thereover wherein said cover covers a top, bottom, and two end surfaces of an area surrounding said load port transfer arm and wherein two side surfaces of said area are open so that said load port transfer arm can move without restraint; and
(b) a means for blowing air around said load port transfer arm and out through openings in said bottom of said cover.

12. The apparatus according to claim 11 wherein said means for blowing air comprises a fan filter.

13. The apparatus according to claim 11 wherein said bottom of said cover comprises an upper layer and a lower layer and wherein a first set of said openings are formed in said upper layer and a second set of openings are formed in said lower layer and wherein said first set of openings and said second set of openings are discontinuous.
